(19) United States
(12) Patent Application Publication
(10) Pub. No.: US 2012/0148922 A1
(43) Pub. Date: Jun. 14, 2012

(54) NEGATIVE ELECTRODE FOR NON-AQUEOUS ELECTROLYTE SECONDARY BATTERY AND METHOD FOR PRODUCING THE SAME

(76) Inventor: Keiichi Takahashi, Hyogo (JP)

(21) Appl. No.: 13/390,468

(22) PCT Filed: Mar. 25, 2011
(86) PCT No.: PCT/JP2011/001753

§ 371 Date: Feb. 14, 2012

(30) Foreign Application Priority Data
Jun. 30, 2010 (JP) 2010-149405

(51) Int. Cl. H01M 4/583; H01R 43/00

(52) U.S. Cl. 429/231.8; 29/825

(57) ABSTRACT

Provided is a negative electrode for a non-aqueous electrolyte secondary battery, the negative electrode having a high capacity and exhibits excellent output/input characteristics in charge and discharge in a low temperature environment and at a high current density. The negative electrode includes a core material, and a negative electrode material mixture layer adhering to the core material. The negative electrode material mixture layer includes a particulate carbon material. The particulate carbon material has a breaking strength of 100 MPa or more. In a diffraction pattern of the negative electrode material mixture layer measured by wide-angle X-ray diffractometry, the ratio of I(101) to I(100) satisfies 1.0<I(101)/I(100)<3.0, and the ratio of I(110) to I(004) satisfies 0.25≦I(110)/I(004)≦0.45.

### TECHNICAL FIELD

The present invention relates to a negative electrode for a non-aqueous electrolyte secondary battery, the negative electrode including a core material and a negative electrode material mixture layer adhering to the core material, and specifically relates to improvement of a negative electrode including a carbon material.

### BACKGROUND ART

In recent years, non-aqueous electrolyte secondary batteries are commonly used as secondary batteries having a high operating voltage and a high energy density and being applicable as a driving power source for portable electronic devices such as cellular phones, notebook personal computers, and video cam coders. A non-aqueous electrolyte secondary battery includes a positive electrode, a negative electrode, and a non-aqueous electrolyte.

For a negative electrode for a non-aqueous electrolyte secondary battery, carbon materials capable of intercalating and deintercalating lithium ions are generally used. Among these, graphite materials are widely used because they can realize a flat discharge potential and a high capacity density (Patent Literatures 1 and 2). Specifically, it is proposed to use a material in which the ratio: I(101)/I(100) of an intensity I(101) of a peak attributed to (101) plane to an intensity I(100) of a peak attributed to (100) plane measured by wide-angle X-ray diffractometry satisfies 0.7≦I(101)/I(100)≦2.2. This peak ratio can serve as an index to show the degree of graphitization. Particularly recommended is a carbon material in which the ratio I(101)/I(100) is 0.8 or more or 1.0 or more (Patent Literature 3).

Recently, development is accelerated not only for non-aqueous electrolyte secondary batteries for use in small consumer applications as mentioned above, but also for non-aqueous electrolyte secondary batteries with large capacity for use in high-output applications such as power storage devices, electric vehicles, and hybrid electric vehicles (HEVs). The applications and required characteristics of large-size non-aqueous electrolyte secondary batteries are different from those of non-aqueous electrolyte secondary batteries for small consumer devices. Batteries used in the above electric vehicles as a driving power source are required to instantaneously contribute to power assist (output) and regeneration (input) of the engine or motor, with their limited capacities. For this reason, high capacity and excellent output/input characteristics are required for these batteries.

In order to improve the output/input characteristics of the battery, it is important to reduce the internal resistance of the battery. In view of this, various studies have been made with respect to the electrode structure, battery components, electrode active materials, electrolytes, and so on. For example, the internal resistance of the battery can be reduced by, for example, improving the current collecting structure of the electrode, increasing the electrode reaction area by using a thinner and longer electrode, or using a material with lower resistance for battery components.

Further, in order to improve the output/input characteristics of the battery in a low temperature environment, it is effective to select and modify an active material. In particular, the charge acceptance of a carbon material used for the negative electrode has a great influence on the output/input characteristics of the battery. In other words, using a carbon material that can readily intercalate and deintercalate lithium ions is effective in improving output/input characteristics of the battery.

In light of this, a negative electrode including a low crystalline carbon material such as a non-graphitizable carbon material has been examined (Patent Literature 4). A non-graphitizable carbon material is low in orientation, in which sites to and from which lithium ions are intercalated and deintercalated are randomly located. Because of this, the charge acceptance thereof is excellent, which is advantageous in improving the output/input characteristics.

### CITATION LIST

### Patent Literature

[PTL 1] Japanese Laid-Open Patent Publication No. 2000-260479
[PTL 2] Japanese Laid-Open Patent Publication No. 2000-260480
[PTL 3] Japanese Laid-Open Patent Publication No. Hei 6-275321
[PTL 4] Japanese Laid-Open Patent Publication No. 2000-200624

### SUMMARY OF INVENTION

### Technical Problem

However, when the electrode including the conventional carbon material as mentioned above is used, particularly the charge/discharge characteristics in a low temperature environment and the cycle characteristics at a high current density tend to deteriorate. Such a battery is difficult to use over a long period of time.

The graphite materials as disclosed in Patent Literatures 1 to 3 have a layered structure and can provide a high capacity density. However, intercalation of lithium ions between graphite layers during charging widens the interlayer spacing. As a result, the graphite material expands. The stress associated with such expansion is gradually increased by repetition of charge at a large current. Consequently, the charge acceptance of the graphite material is degraded gradually, and the cycle life is shortened. Moreover, in graphite, although depending on its particle shape and other factors, the c-axis direction is likely to be oriented perpendicular to the electrode plane, and lithium ion intercalation sites tend to decrease. As such, the charge acceptance of a negative electrode including graphite is likely to degrade.

With regard to the non-graphitizable carbon material as disclosed in Patent Literature 4, the mechanism of charge/discharge reaction thereof is different from that of graphite materials, and lithium is hardly intercalated between layers during charging. Almost all of the lithium ions are inserted in the gaps in the carbon material, and thus, the stress associated with expansion and contraction during charging and discharging is considered smaller than that in the above-mentioned graphite materials. However, in non-graphitizable carbon materials, because of their conductivity lower than that of graphite materials, the internal resistance tends to increase. This trend becomes evident when large-current discharge is repeated.

As described above, non-aqueous electrolyte secondary batteries using the conventional carbon material in the negative electrode are difficult to provide high output and input at the time of charge and discharge in a low temperature environment or at a high current density. This trend becomes evident when the capacity of the negative electrode is improved.

### Solution to Problem

One aspect of the present invention relates to a negative electrode for a non-aqueous electrolyte secondary battery, the negative electrode including a core material, and a negative electrode material mixture layer adhering to the core material. The negative electrode material mixture layer includes a particulate carbon material. The particulate carbon material has a breaking strength of 100 MPa or more. In a diffraction pattern of the negative electrode material mixture layer measured by wide-angle X-ray diffractometry, the ratio of an intensity I(101) of a peak attributed to (101) plane to an intensity I(100) of a peak attributed to (100) plane satisfies 1.0<I(101)/I(100)<3.0, and the ratio of an intensity I(110) of a peak attributed to (110) plane to an intensity I(004) of a peak attributed to (004) plane satisfies 0.25≦I(110)/I(004)≦0.45.

Another aspect of the present invention relates to a method for producing a negative electrode for a non-aqueous electrolyte secondary battery. The method includes the steps of: mixing natural graphite particles with a pitch, to prepare a first precursor; heating the first precursor at 600 to 1000° C. to convert the pitch into a polymerized pitch, thereby to prepare a second precursor; heating the second precursor at 1100 to 1500° C. to carbonize the polymerized pitch, thereby to prepare a third precursor; and heating the third precursor at 2200 to 2800° C. to graphitize the carbonized polymerized pitch, thereby to prepare agglomerates of particulate composite carbon.

### Advantageous Effects of Invention

According to the present invention, it is possible to provide a negative electrode for a non-aqueous electrolyte secondary battery, the negative electrode having a high capacity and exhibits excellent output/input characteristics even in charge and discharge in a low temperature environment or at a high current density.

While the novel features of the invention are set forth particularly in the appended claims, the invention, both as to organization and content, will be better understood and appreciated, along with other objects and features thereof, from the following detailed description taken in conjunction with the drawings.

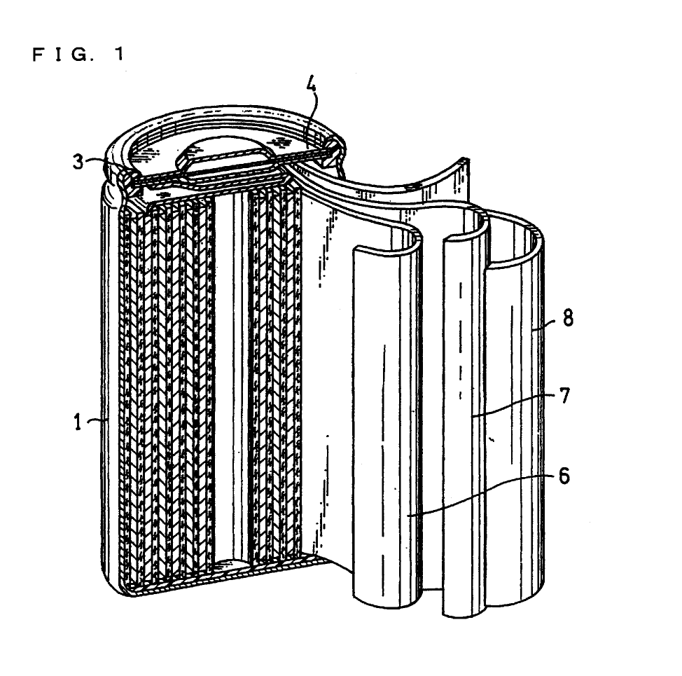

### BRIEF DESCRIPTION OF DRAWING

[FIG. 1] A partially disassembled cross-sectional view showing a configuration of a cylindrical lithium secondary battery according to the present invention.

### DESCRIPTION OF EMBODIMENTS

The negative electrode for a non-aqueous electrolyte secondary battery includes a core material and a negative electrode material mixture layer adhering to the core material. The negative electrode material mixture layer includes a particulate carbon material as an essential component and further includes, for example, a binder as an optional component.

The particulate carbon material has a high breaking strength of 100 MPa or more. As such, after pulverized to have a desired average particle diameter, the particulate carbon material has a surface not being excessively smoothed and having a certain degree of surface roughness. On such a surface of the particulate carbon material, many interlayer planes (edge planes) of the carbon layer tend to appear, which provides excellent charge/discharge characteristics. The breaking strength of the particulate carbon material is preferably 120 to 180 MPa.

The breaking strength of the particulate carbon material can be determined by, for example, the following method.

A particulate carbon material having a particle diameter of 17 to 23 μm and a degree of sphericity of 85% or more is prepared for measurement. The particulate carbon material is compressed with an indenter, with increasing force applied thereto. The force applied thereto when the particulate carbon material ruptures is defined as a breaking strength of the particle. The breaking strength of the particulate carbon material can be measured using a commercially available micro compression tester (e.g., MCT-W500 available from Shimadzu Corporation). For example, in measuring the breaking strength of the particulate carbon material, a flat indenter with a 50-μm-diameter tip is used, and the displacement rate is set at 5 μm/sec.

The particulate carbon material is preferably a particulate composite carbon having a natural graphite portion and an artificial graphite portion. The particulate composite carbon is not merely a mixture of natural graphite particles and artificial graphite particles, and has a natural graphite portion and an artificial graphite portion in one particle. Although the details are unclear, the natural graphite portion and the artificial graphite portion interact with each other, providing the particulate composite carbon with a high breaking strength (e.g., 100 MPa or more). The particulate composite carbon is resistant to breaking, and therefore, even after pressed for increasing the density, it is unlikely to be oriented. In other words, by using the particulate composite carbon, the negative electrode can have a higher density and a charge acceptance in a well-balanced manner. It should be noted that the particulate composite carbon is not necessarily graphitized entirely. For example, the particulate composite carbon may include a carbon portion which is undergoing graphitization.

The particulate composite carbon is unlikely to be oriented even by pressing. This is because the particulate composite carbon has a high breaking strength, and the particle fracture is suppressed. Since the particles are unlikely to be oriented, principally, the reaction resistance component in the internal resistance can be reduced. In other words, the particulate composite carbon is unlikely to deteriorate even when subjected to charge/discharge cycles at a high current density that requires excellent charge acceptance. As such, it is possible to provide a non-aqueous electrolyte secondary battery with excellent charge/discharge cycle characteristics.

In the particulate composite carbon, carbon crystals are bonded continuously from the natural graphite portion to the artificial graphite portion, thus forming a closely-packed structure. Further, natural graphite and artificial graphite are present in a composite manner, thus forming a very fine crystal structure.

The boundary between the natural graphite portion and the artificial graphite portion in the particulate composite carbon can be identified by, for example, observing a cross section of the particle. However, it is sometimes difficult to visually identify the boundary between the natural graphite portion and the artificial graphite portion. In this case, the particle can be verified as the particulate composite carbon by, for example, performing X-ray crystal structure analysis on a small area, to identify the presence of particles having different crystallite sizes. The graphite crystals are preferably continued across the boundary. When graphite crystals continuously extend from the natural graphite portion to the artificial graphite portion, the breaking strength of the particles is improved, and the closely-packed structure is readily obtained.

In the particulate composite carbon, the artificial graphite portion is preferably arranged on the surface of the natural graphite portion. The particulate composite carbon having such a structure has a comparatively uniform shape (e.g., a degree of sphericity of 80 to 95%). As such, stress is to be uniformly applied to the particulate composite carbon, and the particle rupture is suppressed. The surface of the natural graphite portion may be completely covered with the artificial graphite portion, or alternatively, the natural graphite portion may be partially exposed. It suffices if in the particulate composite carbon, the proportion of the artificial graphite portion appearing on the surface is large on average.

The degree of sphericity is a ratio of a circumferential length of a corresponding circle to a circumferential length of a two-dimensional projection image of the particle. The corresponding circle is a circle having the same area as that of the projection area of the particle. The degree of sphericity can be determined by measuring the degree of sphericity of, for example, 10 particles and averaging the measured values.

The weight ratio of the artificial graphite portion in the particulate composite carbon is preferably 60 to 90% by weight, and more preferably 80 to 90% by weight. When the weight ratio of the artificial graphite portion is below 60% by weight, the weight ratio of the natural graphite portion is relatively increased, and the closely-packed structure may not be readily obtained. On the other hand, when the weight ratio of the artificial graphite portion exceeds 90% by weight, the breaking strength of the particulate composite carbon may be lowered. The weight ratio of the artificial graphite portion in the particulate composite carbon can be determined by, for example, observing a cross section of the particulate composite carbon under an electron microscope, to calculate a ratio of the area of the artificial graphite portion to the area of the cross section of the whole particulate composite carbon. Specifically, it can be determined by observing a cross section of the particulate composite carbon having a particle diameter of 10 to 20 μm, to calculate a ratio of the area of the artificial graphite portion to the area of the cross section of the whole particulate composite carbon, and obtaining an average value of, for example, 10 to 20 particles.

Natural graphite particles are readily cleaved. Because of this, in the case where natural graphite particles are pulverized to have a desired particle diameter, the pulverized natural graphite particles have a smooth surface. The proportion of the basal planes of the carbon layer appearing on the surfaces of pulverized natural graphite particles is considered larger than that of the interlayer planes (edge planes) of the carbon layer. At this time, the surface roughness Ra of the pulverized natural graphite particles is, for example, 0.05 μm or less. However, the basal planes make no contribution to intercalation and deintercalation of lithium ions. In short, the charge acceptance of the negative electrode tends to deteriorate if graphite particles are pulverized under a large stress as conventionally.

The particulate composite carbon is synthesized by using a natural graphite core and an artificial graphite raw material, as starting materials. Specifically, the particulate composite carbon can be obtained by, for example, the following method.

First, natural graphite particles are mixed with a pitch, to prepare a first precursor. Here, the natural graphite particles serving as one of the starting materials are preferably pulverized so as to have a sharp particle size distribution. When the natural graphite particles include a large number of particles whose particle diameter is extremely small, the particle size distribution of the pulverized particulate composite carbon may become broad. On the other hand, when the natural graphite particles include a large number of particles whose particle diameter is extremely greater than the desired particle diameter of the particulate composite carbon, the necessity of cleaving at the natural graphite portion arises. As a result of such cleaving, the properties of natural graphite would become predominant in the particulate composite carbon, and the improvement of output/input characteristics may be hindered.

Specifically, the pulverized natural graphite particles preferably include particles of 5 μm or smaller in a ratio of 3% by weight of less. By setting the content of the particles of 5 μm or smaller to 3% by weight of less, a particulate composite carbon having a sharp particle size distribution can be obtained. In a volumetric particle size distribution of the pulverized natural graphite particles, the diameter at 50% volume accumulation is preferably 1.5 to 3 times as large as the diameter at 10% volume accumulation, and the diameter at 90% volume accumulation is preferably 1.1 to 1.5 times as large as the diameter at 50% volume accumulation. The variations in particle diameter of such natural graphite particles are small, and therefore, a particulate composite carbon having a sharp particle size distribution can be obtained. As a result, the packability at the time of rolling is improved.

Next, the first precursor is heated at 600 to 1000° C. to melt the pitch, and is then allowed to stand over a predetermined time in an inert atmosphere. As a result, the pitch is converted into a polymerized pitch, whereby a second precursor is prepared. Thereafter, the second precursor is heated at 1100 to 1500° C., to carbonize the polymerized pitch, whereby a third precursor is prepared.

The third precursor is heated at 2200° C. to 2800° C. in an inert gas atmosphere. As a result of this heating, the carbonized polymerized pitch is graphitized, whereby agglomerates of particulate composite carbon are formed. The graphitization is confirmed by, for example, an improved sharpness of the peaks in XRD. The above carbonization and graphitization are preferably performed in an inert atmosphere, and is preferably performed, for example, in an atmosphere including at least one gas selected from nitrogen and argon.

Thereafter, the agglomerates of particulate composite carbon are processed to have a desired average particle diameter. For example, the agglomerates are pulverized and classified. Agglomerates are easily pulverized, and therefore, can be readily controlled to have a desired average particle diameter even if the stress of pulverization is reduced. For this reason, the pulverized particulate composite carbon has a surface on which the edge planes of the carbon layer sufficiently appear, and thus exhibits excellent charge acceptance.

The pulverized particulate carbon material preferably has a surface roughness Ra of 0.2 to 0.6 μm. The above agglomerates of particulate composite carbon have a discontinuous structure and, therefore, are easily pulverized. As such, even if the stress of pulverization is comparatively small, the particulate composite carbon can be readily controlled to have a desired particle diameter. Since the stress of pulverization can be reduced, the surface of the particulate composite carbon is not smoothed excessively, and a certain degree of surface roughness thereof is maintained. It is considered that on the surface of the particulate composite carbon having such a surface roughness, the edge planes of the carbon layer appear sufficiently. This allows lithium ions to be intercalated smoothly during charge and to be deintercalated smoothly during discharge. In other words, by using the particulate composite carbon, the charge acceptance of the negative electrode is improved.

The surface roughness of the particulate carbon material can be measured using, for example, a scanning probe microscope (SPM). For example, the surface roughness is measured with respect to a particle having a particle diameter of 10 to 20 μm, as an average value of 10 to 20 particles.

The average particle diameter (i.e., the particle diameter at 50% volume accumulation in a volumetric particle size distribution: D50) of the particulate carbon material is not particularly limited, but is preferably 5 to 25 μm. The particulate carbon material preferably has a sharp particle size distribution. Specifically, the content of particles of 5 μm or smaller is preferably 5% by weight or less. The diameter at 50% volume accumulation in a volumetric particle size distribution of the particulate carbon material is preferably 2 to 3.5 times as large as the diameter at 10% volume accumulation (D10), and the diameter at 90% volume accumulation (D90) is preferably 2 to 2.7 times as large as the above diameter at 50% volume accumulation. The variations in particle diameter of such a particulate carbon material are small, and thus, the packability thereof at the time of rolling the negative electrode material mixture layer is improved.

The BET specific surface area of the particulate carbon material is preferably 1 to 5 m²/g. This provides excellent charge/discharge cycle characteristics as well as excellent output/input characteristics. When the BET specific surface area of the particulate carbon material is below 1 m²/g, it may be difficult to improve the output/input characteristics. On the other hand, when the BET specific surface area exceeds 5 m²/g, the influence due to the side reaction between the non-aqueous electrolyte and the particulate carbon material may become evident. The BET specific surface area of the particulate carbon material is more preferably 1.5 to 3 m²/g. The BET specific surface area of the particulate carbon material can be determined from the amount of nitrogen adsorbed onto the particulate carbon material.

The particulate carbon material preferably has an amorphous carbon layer on the surface thereof. In the case where the particulate carbon material is a particulate composite carbon, at least one of the artificial graphite portion and the natural graphite portion has an amorphous carbon layer on the surface thereof. Since the amorphous carbon layer does not have a regular structure, lithium ions are readily absorbed therein. As such, the charge acceptance of the negative electrode is further improved.

The method of disposing an amorphous carbon layer on the surface of the particulate carbon material is not particularly limited. The particulate carbon material may be coated with an amorphous carbon layer by a vapor phase method or a liquid phase method. For example, an organic material such as pitch is allowed to adhere to the surface and then subjected to reduction treatment, so that it becomes amorphous, or alternatively, the particulate carbon material is heated in a reducing atmosphere such as an acetylene gas atmosphere, thereby to coat the surface with an amorphous carbon layer.

The negative electrode includes a core material, and a negative electrode material mixture layer adhering to a surface thereof. The negative electrode material mixture layer includes a particulate carbon material as an essential component, and further includes, for example, a binder as an optional component. The negative electrode current collector is not particularly limited, and may be a sheet made of, for example, stainless steel, nickel, or copper.

The negative electrode material mixture layer contains the particulate carbon material preferably in a ratio of 90 to 99% by weight, and more preferably 98 to 99% by weight. The negative electrode material mixture layer containing the particulate carbon material in a ratio within the above range can have a high capacity and a high strength.

The negative electrode material mixture layer can be obtained by preparing a negative electrode material mixture paste, applying the paste onto one surface or both surfaces of the core material, and drying the paste. The negative electrode material mixture paste is, for example, a mixture of a particulate carbon material, a binder, a thickener, and a dispersion medium. The negative electrode material mixture layer is then pressed using, for example, rollers, whereby a negative electrode having a high active material density and a high strength can be obtained.

A diffraction pattern of the negative electrode measured by wide-angle X-ray diffractometry provides information on the crystallinity of the particulate carbon material included in the negative electrode. The negative electrode including the particulate carbon material has, in a diffraction pattern thereof measured by wide-angle X-ray diffractometry, a peak attributed to (101) plane and a peak attributed to (100) plane.

In an X-ray diffraction pattern of the negative electrode measured using Cu—Kα rays, a peak attributed to (100) plane is observed at around 2θ=42°. At around 2θ=44°, a peak attributed to (101) plane is observed. The peak attributed to (101) plane indicates a development of the three-dimensional graphite structure. Specifically, the larger the ratio I(101)/I(100) is, the more the graphite structure is developed.

In the negative electrode according to the present invention, the ratio of an intensity I(101) of the peak attributed to (101) plane to an intensity I(100) of the peak attributed to (100) plane satisfies 1.0<I(101)/I(100)<3.0. Here, the intensity of the peak means a height of the peak. I(101)/I(100) being 1 or less indicates an insufficient development of the three-dimensional graphite structure. In this case, a sufficiently high capacity cannot be obtained. On the other hand, when I(101)/I(100) is 3 or more, the properties of natural graphite become predominant, and the basal planes tend to be oriented. This results in a structure with low Li-acceptance.

I(101)/I(100) is more preferably 2.6 or less, and particularly preferably 2.5 or less. I(101)/I(100) is more preferably 2.2 or more, and further preferably 2.3 or more.

The negative electrode including the particulate carbon material further has a peak attributed to (110) plane and a peak attributed to (004) plane in the above X-ray diffraction pattern.

The peak attributed to (110) plane is observed at around 2θ=78°. This peak represents the diffraction due to a plane parallel to the c-axis. Accordingly, the peak intensity I(110) tends to be small as the basal planes of graphite in the negative electrode are more oriented along the plane of the electrode.

The peak attributed to (004) plane is observed at around 2θ=54°. This peak represents the diffraction due to a plane parallel to the a-axis. Accordingly, the peak intensity I(004) tends to be large as the basal planes of graphite in the negative electrode are more oriented along the plane of the electrode.

Specifically, the smaller the ratio I(110)/I(004) is, the more the basal planes are oriented along the plane of the electrode.

In the negative electrode according to the present invention, the ratio of an intensity I(110) of the peak attributed to (110) plane to an intensity I(004) of the peak attributed to (004) plane satisfies 0.25≦I(110)/I(004)≦0.45. When I(110)/I(004) is below 0.25, the particulate composite carbon is too highly oriented, and therefore, the speed of the intercalation and deintercalation of lithium ions is slowed. As a result, the output/input characteristics of the negative electrode may deteriorate.

I(110)/I(004) is particularly preferably 0.29 or more and 0.37 or less.

The crystallite thickness Lc(004) along the c-axis of the particulate carbon material used in the present invention is preferably 20 nm or more and less than 60 nm, in view of the charge acceptance and the capacity. The crystallite thickness La along the a-axis is preferably 50 nm or more and 200 nm or less, in view of achieving a higher capacity.

Both Lc and La can be expressed by a function of the half-width of a peak observed in the X-ray diffraction pattern. The half-width of a peak can be determined by, for example, the following method.

Highly pure silicon powder serving as an internal reference material is mixed with the particulate carbon material. The X-ray diffraction pattern of the resultant mixture is measured, to obtain half-widths of peaks of carbon and silicon, from which a crystallite thickness is calculated. Lc is determined from the peak attributed to (004) plane. La is determined from the peak attributed to (110) plane.

The particulate carbon material according to the present invention is unlikely to be oriented, and therefore, even when the packing density of the negative electrode material mixture layer is increased to 1.6 to 1.8 g/cm³, favorable charge acceptance can be obtained. In other words, a high energy density and excellent output/input characteristics can be achieved in a well-balanced manner. The packing density is a weight of the negative electrode material mixture layer per unit volume.

The capacity density of the negative electrode material mixture layer is 315 to 350 Ah/kg. Although the theoretical capacity of graphite is 372 Ah/kg, it is difficult to design such that the negative electrode material mixture layer has a capacity density of 315 Ah/kg or more, in the case where general graphite is used as the negative electrode material. However, according to the present invention, by using the particulate carbon material as described above, excellent charge acceptance can be obtained. Therefore, the capacity density of the negative electrode material mixture layer can be increased to as much as, for example, 315 to 350 Ah/kg.

The capacity density of the negative electrode material mixture layer is determined by dividing a capacity obtainable from the battery in a fully charged state by a weight of the particulate carbon material contained in a portion of the negative electrode material mixture layer, the portion facing the positive electrode material mixture layer.

A fully charged state is a state in which the battery is charged until the battery voltage reaches a predetermined charge upper-limit voltage. The battery charged beyond the charge upper-limit voltage falls into an overcharged state. The charge upper-limit voltage is generally set within the battery voltage range of 4.1 to 4.4 V.

In the case where the negative electrode material mixture layer is formed to adhere to both surfaces of the negative electrode core material, the total thickness of the negative electrode material mixture layers, excluding the core material, is preferably 50 to 250 μm. When the total thickness of the negative electrode material mixture layers is below 50 μm, a sufficiently high capacity may not be obtained. On the other hand, when the total thickness of the negative electrode material mixture layers exceeds 250 μm, the charge acceptance may be degraded, and Li may be deposited.

A non-aqueous electrolyte secondary battery includes the above-described negative electrode, a positive electrode, and a non-aqueous electrolyte. The positive electrode includes a positive electrode core material and a positive electrode material mixture layer adhering to a surface thereof.

The positive electrode material mixture layer generally includes a positive electrode active material comprising a lithium-containing composite oxide, a conductive material, and a binder. For the conductive material and the binder, any known conductive material and binder may be used without particular limitation.

The positive electrode current collector may be a sheet made of, for example, stainless steel, aluminum, or titanium.

In the case where the positive electrode material mixture layer is formed to adhere to both surfaces of the positive electrode core material, the total thickness of the two positive electrode material mixture layers is preferably 50 μm to 250 μm.

In the case where the positive electrode material mixture layer is formed to adhere to both surfaces of the positive electrode core material, the total thickness of the two positive electrode material mixture layers is preferably 50 μm to 250 μm. When the total thickness of the positive electrode material mixture layers is below 50 μm, a sufficiently high capacity may not be obtained. On the other hand, when the total thickness of the positive electrode material mixture layers exceeds 250 μm, the internal resistance of the battery tends to increase.

For a lithium-containing composite oxide being the positive electrode active material, any known lithium-containing composite oxide may be used without particular limitation. For example, LiCoO₂, LiNiO₂, or LiMn₂O₄ having a spinel structure may be used. Alternatively, in order to improve the cycle life characteristics, the transition metal contained in the composite oxide may be partially replaced with another element. For example, by using a lithium nickel composite oxide obtained by partially replacing Ni element in LiNiO₂ with Co or other elements (e.g., Al, Mn, and Ti), charge/discharge cycle characteristics at a high current density and output/input characteristics can be achieved in a balanced manner.

Examples of the conductive material include: graphites; carbon blacks, such as acetylene black, Ketjen black, channel black, furnace black, lamp black, and thermal black; carbon fibers; and metal fibers.

Examples of the positive electrode binder and the negative electrode binder include a polyolefin binder, a fluorinated resin, and a particulate binder with rubber elasticity. Examples of the polyolefin binder include polyethylene and polypropylene. Examples of the fluorinated resin include polytetrafluoroethylene (PTFE), polyvinylidene fluoride (PVDF), tetrafluoroethylene-hexafluoropropylene copolymer (FEP), and vinylidene fluoride-hexafluoropropylene copolymer. Examples of the particulate binder with rubber elasticity include a copolymer having styrene units and butadiene units (SBR).

The non-aqueous electrolyte is preferably a liquid electrolyte comprising a non-aqueous solvent and a lithium salt dissolved therein. Examples of the non-aqueous solvent include mixed solvents of: cyclic carbonates such as ethylene carbonate, propylene carbonate, and butylene carbonate; and chain carbonates such as dimethyl carbonate, diethyl carbonate, and ethyl methyl carbonate. Examples thereof further include γ-butyrolactone and dimethoxyethane. Examples of the lithium salt include an inorganic lithium fluoride and a lithium imide compound. The inorganic lithium fluoride is, for example, LiPF₆ or LiBF₄, and the lithium imide compound is, for example, LiN(CF₃SO₂)₂.

A separator is generally interposed between the positive electrode and the negative electrode. Examples of the separator include microporous films, woven fabrics, and non-woven fabrics. The films and fabrics may be made of polyolefin such as polypropylene and polyethylene. Polyolefin is excellent in durability and has a shutdown function, and therefore is preferable in view of improving the safety of the secondary battery.

The present invention is specifically described below with reference to Examples. It should be noted, however, that the present invention is not limited to these Examples.

### Example 1

### (i) Production of Positive Electrode

First, 100 parts by weight of a lithium-containing composite oxide (LiNi_{0.8}Co_{0.15}Al_{0.05}O₂, average particle diameter: 12 μm) serving as a positive electrode active material, 5 parts by weight of polyvinylidene fluoride (PVDF #1320 (N-methyl-2-pyrrolidone (NMP) solution with solid content 12 wt %, available from Kureha Chemical Industry Co., Ltd.) serving as a binder, 4 parts by weight of acetylene black serving as a conductive material, and an appropriate amount of NMP serving as a dispersion medium were mixed in a double arm kneader, to prepare a positive electrode material mixture paste. The positive electrode material mixture paste was applied onto both surfaces of a 20-μm-thick aluminum foil (a positive electrode core material), and the resultant films were dried. Thereafter, the films were rolled with rollers until the overall thickness of the positive electrode reached 160 μm, to produce a positive electrode. The positive electrode thus produced was cut to a width insertable into a cylindrical 18650 battery case.

### (ii) Production of Negative Electrode

Natural graphite (available from Kansai Coke and Chemicals Co., Ltd., average particle diameter: 25 μm) was pulverized in a jet mill (Co-Jet, available from Seishin Enterprise Co., Ltd.) to be 3 μm or more and 15 μm or less in diameter.

The pulverized natural graphite was added in a weight ratio as shown in Table 1, to 100 parts by weight of pitch available from Mitsubishi Gas Chemical Company, Inc. (product type: AR24Z, softening point: 293.9° C.), and these were mixed with 5 parts by weight of para-xylene glycol serving as a cross-linking agent, and 5 parts by weight of boric acid serving as a catalyst for graphitization. The temperature of the resultant mixture (a first precursor) was raised to 600° C. under normal pressure in a nitrogen atmosphere, to melt the pitch, and the pitch was kept in a molten state for 2 hours to allow polymerization to proceed, whereby the pitch was converted into a polymerized pitch.

A second precursor including the polymerized pitch was heated at 1200° C. for 1 hour in a nitrogen atmosphere, to carbonize the polymerized pitch. Thereafter, a third precursor including the carbonized polymerized pitch was heated at 2800° C. in an argon atmosphere, to give agglomerates of particulate composite carbon being a particulate carbon material. The agglomerates of particulate composite carbon thus obtained were pulverized and classified.

Next, the resultant particulate carbon material was heated at 1200° C. in a stream of ethylene, to form an amorphous carbon layer on the surface of at least one of the natural graphite portion and the artificial graphite portion. Observation under a transmission electron microscope (TEM) showed that the thickness of the amorphous carbon layer was 10 to 15 nm.

The average particle diameter (D50) and BET specific surface area of the particulate composite carbon with the amorphous carbon layer formed thereon are shown in Table 1.

The breaking strength of the particulate composite carbon was measured using a micro-compression testing machine (MCT-W500, available from Shimadzu Corporation). With respect to 10 particles having a particle diameter of 20 μm, the breaking strength was measured, and the measured values were averaged. The results are shown in Table 1.

The degree of sphericity of the particulate composite carbon was determined using an image analysis software, from a circumferential length of the two-dimensional projection image of the particulate composite carbon and a circumferential length of the corresponding circle. The degree of sphericity was determined as an average of the measured values of 10 particles. The results are shown in Table 1.

The cross section of the particulate composite carbon produced above was observed using an SEM, and the result found that the particulate composite carbon had a natural graphite portion and an artificial graphite portion formed on the surface of the natural graphite portion. From the ratio of an area of the artificial graphite portion to a whole cross-sectional area of the particulate composite carbon having a particle diameter of 20 μm, the weight ratio of the artificial graphite portion in the particulate composite carbon was determined. The weight ratio of the artificial graphite portion in the particulate composite carbon was determined as an average of the measured values of 10 particles. The results are shown in Table 1.

The surface roughness of the particulate composite carbon was measured using a scanning probe microscope (SPM, E-Sweep, available from SII nanotechnology Inc.). The results are shown in Table 1.

The orientation of the particulate composite carbon obtained above was analyzed by powder X-ray diffractometry. Lc(004) and La(110) were determined by using highly pure silicon powder as an internal reference material. The results are shown in Table 1.

Next, 100 parts by weight of the particulate composite carbon, 1 part by weight of BM-400B available from Zeon Corporation, Japan (a dispersion of modified styrene-butadiene rubber (SBR) with solid content 40 wt %) serving as a binder, 1 part by weight of carboxymethyl cellulose (CMC) serving as a thickener, and an appropriate amount of water serving as a dispersion medium were mixed using a double arm kneader, to prepare a negative electrode material mixture paste. The negative electrode material mixture paste was applied onto both surfaces of a 10-μm-thick copper foil (a negative electrode core material), and the resultant films were dried. Thereafter, the films were rolled with rollers until the overall thickness of the negative electrode reached 160 μm, to produce a negative electrode. The negative electrode thus produced was cut to a width insertable into a cylindrical 18650 battery case.

The orientation of particles in the negative electrode thus produced was analyzed by wide-angle X-ray diffractometry. The results are shown in Table 1.

The wide-angle X-ray diffraction pattern of the negative electrode was measured using Cu—Kα rays. A peak attributed to (100) plane was observed at around 2θ=42°, and a peak attributed to (101) plane was observed at around 44°. A peak attributed to (110) plane was observed at around 2θ=78°, and a peak attributed to (004) plane was observed at around 2θ=54°.

The background was removed from the diffraction pattern, and the ratios I(101)/I(100) and I(110)/I(004) were determined from the peak intensities (the heights of the peaks). The results are shown in Table 2.

### (iii) Preparation of Non-Aqueous Electrolyte

First, 2% by weight of vinylene carbonate, 2% by weight of vinylethylene carbonate, 5% by weight of fluorobenzene, and 5% by weight of phosphazene were added to a mixed solvent containing ethylene carbonate and methyl ethyl carbonate in a ratio of 1:3 by volume. LiPF₆ was then dissolved in a ratio of 1.5 mol/L in the resultant mixed solvent, to prepare a non-aqueous electrolyte.

### (iv) Fabrication of Battery

A non-aqueous electrolyte secondary battery as shown in FIG. 1 was fabricated.

One end of a positive electrode lead was connected to an exposed portion of the positive electrode core material, and one end of a negative electrode lead was connected to an exposed portion of the negative electrode core material. A positive electrode 6 and a negative electrode 8 were wound spirally with a 27-mm-thick and 50-mm-wide separator 7 made of a polyethylene microporous film, to form a cylindrical electrode group having an approximately circular cross section.

On the top and bottom of the electrode group, upper and lower insulating rings (not shown) were arranged, respectively. The electrode group was inserted into a cylindrical battery case 1 having a diameter of 18 mm and a height of 61.5 mm. The other end of the negative electrode lead was welded to the inner bottom surface of the battery case 1. The non-aqueous electrolyte was injected into the battery case 1, and was allowed to impregnate into the electrode group by a pressure reduction method. The other end of the positive electrode lead was welded to the inner side of a sealing member 4, and then the battery case 1 was sealed with the sealing member 4 with a gasket 3 interposed therebetween, whereby a battery was fabricated.

### Examples 2 to 4

Negative electrodes were produced in the same manner as in Example 1, except that the weight ratios of the natural graphite portion and artificial graphite portion were changed as shown in Table 1. Batteries of Examples 2 to 4 were fabricated in the same manner as in Example 1, except that the resultant negative electrodes were used.

### Comparative Example 1

First, 100 parts by weight of pitch available from Mitsubishi Gas Chemical Company, Inc. (product type: AR24Z, softening point: 293.9° C.) was mixed with 5 parts by weight of para-xylene glycol serving as a cross-linking agent, and 5 parts by weight of boric acid serving as a catalyst for graphitization. The temperature of the resultant mixture (a first precursor) was raised to 300° C. under normal pressure in a nitrogen atmosphere, to melt the pitch, and the pitch was kept in a molten state for 2 hours to allow polymerization to proceed, whereby the pitch was converted into a polymerized pitch.

A second precursor including the polymerized pitch was heated at 800° C. for 1 hour in a nitrogen atmosphere, to carbonize the polymerized pitch. Thereafter, a third precursor including the carbonized polymerized pitch was heated at 2800° C. in an argon atmosphere, to give agglomerates of artificial graphite particles. The agglomerates of artificial graphite particles thus obtained were pulverized and classified, so that the average particle diameter (D50) reached 20 μm. The breaking strength, surface roughness, degree of sphericity, and BET specific surface area of the artificial graphite particles were determined in the same manner as in Example 1. A negative electrode was produced in the same manner as in Example 1, except that the artificial graphite particles thus prepared were used, and a battery was fabricated in the same manner as in Example 1.

The batteries of Examples 1 to 4 and Comparative Example 1 were evaluated as follows.

### [Initial Capacity]

The batteries were subjected to 3 charge/discharge cycles in a 25° C. environment at a constant current of 400 mA, with the charge upper-limit voltage being set at 4.2 V and the discharge lower-limit voltage being set at 2.5 V. The discharge capacity at the 3rd cycle was defined as an initial capacity of the battery. The results are shown in Table 2.

### [Internal Resistance]

The batteries were charged at a constant current of 400 mA in a 25° C. environment until the state of charge (SOC) reached 50%. Thereafter, pulse discharge and pulse charge were repeated, each for a duration of 10 seconds at 100 mA, 200 mA, 400 mA and 1000 mA, and the voltage at the 10th second in each pulse discharge was measured to make plots of current-voltage characteristics. The plotted points were approximated to a line by a least squares method, and the slope of the approximate line was defined as a direct current internal resistance (DC-IR). Further, in a 0° C. environment also, the DC-IR was measured in the same manner. The results are shown in Table 2.

### [Charge/Discharge Cycle Characteristics at Low Temperature]

The batteries having been subjected to DC-IR measurement were evaluated as follows.

The batteries of Examples 1 to 4 and Comparative Example 1, one for each example, were used. The batteries were subjected to 100 charge/discharge cycles in a 0° C. environment at a constant current of 400 mA, with the charge upper-limit voltage being set at 4.2 V and the discharge lower-limit voltage being set at 2.5 V. Every after 100 cycles, the batteries were returned in the 25° C. environment, wherein the discharge capacity and DC-IR were measured. This process was repeated to perform 500 charge/discharge cycles in total, to determine a capacity retention rate at low temperature after 500 cycles relative to the initial capacity. The results are shown in Table 2.

TABLE 1

| | Weight | Weight | | | | Degree | BET | | |
|---|---|---|---|---|---|---|---|---|---|
| | ratio of | ratio of | Average | Surface | Break- | of | specific | | |
| | natural | artificial | particle | rough- | ing | spheri- | surface | | |
| | graphite | graphite | diameter | ness | strength | city | area | Lc(004) | La(110) |
| | (wt %) | (wt %) | (μm) | (μm) | (MPa) | (%) | (m²/g) | (nm) | (nm) |
| Ex. 1 | 40 | 60 | 21.1 | 0.45 | 125 | 86 | 3.1 | 40 | 72 |
| Ex. 2 | 30 | 70 | 21.5 | 0.57 | 184 | 86 | 3.5 | 43 | 74 |
| Ex. 3 | 20 | 80 | 22.4 | 0.32 | 153 | 85 | 3.3 | 36 | 70 |
| Ex. 4 | 10 | 90 | 22.8 | 0.23 | 114 | 82 | 2.9 | 33 | 66 |
| Com. | 0 | 100 | 20.5 | 0.19 | 96 | 78 | 2.8 | 32 | 54 |
| Ex. 1 | | | | | | | | | |

TABLE 2

| | | | | | | | | Capacity |
|---|---|---|---|---|---|---|---|---|
| | | | | | | DC-IR | DC-IR | retention |
| | Packing | Capacity | | | Initial | at | at | rate at low |
| | density | density | I (101)/ | I (110)/ | capacity | 25° C. | 0° C. | temperature |
| | (g/cm³) | (Ah/kg) | I (100) | I (004) | (Ah) | (mΩ) | (mΩ) | (%) |
| Ex. 1 | 1.75 | 315 | 2.555 | 0.387 | 1960 | 30.8 | 58.3 | 90.4 |
| Ex. 2 | 1.75 | 315 | 2.724 | 0.443 | 1970 | 28.6 | 54.6 | 92.5 |
| Ex. 3 | 1.75 | 315 | 2.561 | 0.315 | 1990 | 29.4 | 56.6 | 87.9 |
| Ex. 4 | 1.75 | 315 | 2.269 | 0.286 | 2010 | 29.8 | 59.8 | 83.1 |
| Com. | 1.75 | 315 | 2.249 | 0.187 | 2020 | 33.2 | 63.1 | 79.3 |
| Ex. 1 | | | | | | | | |

As shown in Table 2, the batteries of Examples 1 to 4 exhibited excellent charge/discharge cycle characteristics at low temperature. The batteries of Examples 1 to 4 include a particulate composite carbon. The particulate composite carbon has a high breaking strength and, therefore, is unlikely to break. Presumably because of this, the orientation in the negative electrode was low, and as a result, the charge acceptance was improved, and the charge/discharge cycle characteristics at low temperature were improved. Further, the particulate composite carbons included in Examples 1 to 4 are easy to be pulverized. Therefore, the surfaces thereof were not smoothed excessively even after pulverized, and had a certain degree of surface roughness.

In contrast, the battery of Comparative Example 1 exhibited significant deterioration in the charge/discharge cycle characteristics at low temperature. This is presumably because in the particulate carbon material of Comparative Example 1, because of its low breaking strength, the proportion of basal planes of the carbon layer appearing on the surfaces of the particles was increased after pulverization, and the charge acceptance became insufficient.

In the battery of Comparative Example 1 including a carbon material in which the orientation was high, that is, the I(110)/I(004) value was as small as 0.187, the DC-IR values in 0° C. and 25° C. environments were high. This means that the output characteristics at low temperature of the battery of Comparative Example 1 deteriorated. This is presumably because a higher orientation decelerates the speed of intercalation and deintercalation of lithium ions at low temperature.

On the other hand, in the batteries of Examples 1 to 4 including a composite carbon material in which the orientation was lower than that in Comparative Example 1, that is, the I(110)/I(004) values were 0.28 or more, the output characteristics at low temperature were favorable. This result suggests that the orientation in the carbon material has greater influence on the output characteristics at low temperature than the degree of graphitization of the carbon material.

A detail analysis on the particle size distribution of the particulate composite carbon included in Example 3 showed that the content of particles of 5 μm or smaller was 5% by weight of less, D50 was about 3 times as large as D10, and D90 was about 2.5 times as large as D50.

### Examples 5 to 8 and Comparative Example 2

### (i) Production of Positive Electrode

A positive electrode was produced in the same manner as in Example 1, except that a lithium-nickel composite oxide represented by the compositional formula, LiNi_{0.4}Co_{0.3}Mn_{0.3}O₂ was used.

### (ii) Production of Negative Electrode

Negative electrodes of Examples 5 to 8 and Comparative Example 2 were produced in the same manner as in the battery of Example 3, except that the line pressure between rollers at the time of rolling was changed, so that the packing density was changed as shown in Table 3. The negative electrodes thus produced were subjected to measurement by wide-angle X-ray diffractometry. The I(101)/I(100) and I(110)/I(004) values are shown in Table 3.

Batteries of Examples 5 to 8 and Comparative Example 2 were produced in the same manner as in Example 1, except that the positive electrode and the negative electrodes produced above were used. The resultant batteries were evaluated in the same manner as in Example 1. The results are shown in Table 3.

TABLE 3

| | Weight | | | | | | | Capacity |
|---|---|---|---|---|---|---|---|---|
| | ratio of | | | | | DC-IR | DC-IR | retention |
| | artificial | Packing | | | Initial | at | at | rate at low |
| | graphite | density | I (101)/ | I (110)/ | capacity | 25° C. | 0° C. | temperature |
| | (wt %) | (g/cm³) | I (100) | I (004) | (Ah) | (mΩ) | (mΩ) | (%) |
| Ex. 5 | 80 | 1.65 | 2.843 | 0.365 | 2010 | 28.4 | 55.7 | 93.7 |
| Ex. 6 | 80 | 1.70 | 2.752 | 0.352 | 2000 | 27.5 | 53.5 | 92.2 |
| Ex. 7 | 80 | 1.76 | 2.524 | 0.297 | 1990 | 27.2 | 52.4 | 91.5 |
| Ex. 8 | 80 | 1.80 | 2.235 | 0.286 | 1990 | 27.2 | 53.4 | 85.6 |
| Com. | 80 | 1.85 | 2.145 | 0.195 | 1940 | 29.5 | 57.2 | 78.5 |
| Ex. 2 | | | | | | | | |

In Examples 5 to 8 including a particulate composite carbon, even though the packing density was changed within the range of 1.65 to 1.8 g/cm³, the I(110)/I(004) values were 0.2 or more, showing their excellent charge/discharge cycle characteristics at low temperature. This indicates that in a negative electrode including a particulate composite carbon, the particles were unlikely to be oriented even though the packing density was increased to as high as 1.8 g/cm³, and thus, the charge/discharge cycle characteristics at low temperature were improved. On the other hand, in the battery of Comparative Example 2, in which the packing density exceeded 1.8 g/cm³, the charge/discharge cycle characteristics at low temperature were degraded by some extent.

### Examples 9 to 12

Particulate composite carbons were prepared in the same manner as in Example 1, except that boron oxide was used as a catalyst for graphitization in place of the boric acid, and the amount of the boron oxide per 100 parts by weight of pitch available from Mitsubishi Gas Chemical Company, Inc. (product type: AR24Z, softening point: 293.9° C.) was changed as shown in Table 4. The breaking strength, surface roughness, degree of sphericity, and BET specific surface area of the particulate composite carbons thus prepared were determined in the same manner as in Example 1. The results are shown in Table 4.

The cross sections of the particulate composite carbons produced above were observed using an SEM, and the result found that the particulate composite carbons had a natural graphite portion and an artificial graphite portion formed on the surface of the natural graphite portion. The weight ratio of the artificial graphite portion in the particulate composite carbon was determined in the same manner as in Example 1. The results are shown in Table 4.

Negative electrodes were produced in the same manner as in Example 1, except that the particulate composite carbons thus obtained were used. The I(101)/I(100) and I(110)/I(004) values were determined in the same manner as in Example, 1. The results are shown in Table 5.

Batteries of Examples 9 to 12 and Comparative Example 3 were fabricated in the same manner as in Example 1, except that the above negative electrodes were used. The batteries were evaluated in the same manner as in Example 1. The results are shown in Table 5.

### Comparative Example 3

Artificial graphite particles were prepared in the same manner as in Comparative Example 1, except that boron oxide was used as a catalyst for graphitization in place of the boric acid, and the amount of the boron oxide per 100 parts by weight of pitch available from Mitsubishi Gas Chemical Company, Inc. (product type: AR24Z, softening point: 293.9° C.) was changed to 6 parts by weight. The resultant artificial graphite particles were pulverized and classified. A negative electrode was produced, and then a battery was fabricated in the same manner as in Example 1, except that the artificial graphite particles thus prepared were used. The breaking strength, surface roughness, degree of sphericity, and BET specific surface area of the artificial graphite particles thus prepared were determined in the same manner as in Example 1. The results are shown in Table 4.

TABLE 4

| | Adding | Weight | | | Degree | BET |
|---|---|---|---|---|---|---|
| | amount | ratio of | Surface | Break- | of | specific |
| | of boron | artificial | rough- | ing | sphe- | surface |
| | oxide | graphite | ness | strength | ricity | area |
| | (pts · wt) | (wt %) | (μm) | (MPa) | (%) | (m²/g) |
| Ex. 9 | 3 | 80 | 0.21 | 110 | 85 | 1.3 |
| Ex. 10 | 5 | 80 | 0.34 | 139 | 84 | 3.3 |
| Ex. 11 | 8 | 80 | 0.45 | 147 | 85 | 3.3 |
| Ex. 12 | 10 | 80 | 0.55 | 154 | 83 | 4.7 |
| Com. | 6 | 100 | 0.19 | 96 | 76 | 6.4 |
| Ex. 3 | | | | | | |

TABLE 5

| | | | | | | | Capacity |
|---|---|---|---|---|---|---|---|
| | Packing | | | | DC-IR at | DC-IR at | retention- |
| | density | I (101)/ | I (110)/ | Initial | 25° C. | 0° C. | rate at low |
| | (g/cm³) | I (100) | I (004) | capacity (Ah) | (mΩ) | (mΩ) | temperature (%) |
| Ex. 9 | 1.75 | 2.435 | 0.365 | 1940 | 27.4 | 55.7 | 93.5 |
| Ex. 10 | 1.75 | 2.328 | 0.352 | 1960 | 27.6 | 55.2 | 92.6 |
| Ex. 11 | 1.75 | 2.275 | 0.297 | 1980 | 27.9 | 54.7 | 92.4 |
| Ex. 12 | 1.75 | 2.269 | 0.286 | 1990 | 27.6 | 53.4 | 91.3 |
| Com. | 1.75 | 2.188 | 0.176 | 2030 | 31.7 | 61.4 | 86.7 |
| Ex. 3 | | | | | | | |

The batteries of Examples 9 to 12 in which the surface roughness of the particulate composite carbon was 0.2 to 0.6 μm exhibited excellent charge/discharge cycle characteristics at low temperature. On the other hand, the battery of Comparative Example 3 in which the surface roughness was less than 0.2 μm exhibited somewhat deteriorated charge/discharge cycle characteristics at low temperature. The particulate composite carbons included in Examples 9 to 12 are easy to be pulverized, and presumably because of this, the surfaces thereof were kept in such a state that the edge planes of the carbon layer appear thereon sufficiently, and thus, excellent output/input characteristics were obtained.

The foregoing results show that a preferable BET specific surface area of the particulate composite carbon is 1 to 5 m²/g. The battery of Comparative Example 3 in which the BET specific surface area was 6.4 m²/g exhibited deteriorated charge/discharge cycle characteristics. This is presumably because the BET specific surface area was excessively large, making the negative electrode surface reactive (side reaction) with the non-aqueous electrolyte.

Although a lithium nickel composite oxide was used as the positive electrode active material in the above Examples and Comparative Examples, for example, other lithium-containing composite oxides, such as a lithium manganese composite oxide and a lithium cobalt composite oxide, can be used with similar effects.

Further, a particulate composite carbon synthesized in the same manner as in Example 1 except for forming no amorphous layer can be used with similar effects, although the effects tend to be less evident.

Further, although a mixed solvent of ethylene carbonate and methyl ethyl carbonate was used as the non-aqueous solvent of the non-aqueous electrolyte in the above Examples and Comparative Examples, any known non-aqueous solvent having an oxidation/reduction resistant potential of 4 V level (e.g., diethyl carbonate (DEC), butylene carbonate (BC), and methyl propionate) can be used with similar effects. Further, for the solute to be dissolved in the non-aqueous solvent, any known solute, such as LiBF₄ and LiClO₄, can be used with similar effects.

### INDUSTRIAL APPLICABILITY

The negative electrode for a non-aqueous electrolyte secondary battery according to the present invention can be utilized as a power source for devices required to provide high output/input.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1: Battery case
3: Gasket
4: Sealing member
6: Positive electrode
7: Separator
8: Negative electrode

1. A negative electrode for a non-aqueous electrolyte secondary battery,
the negative electrode comprising a core material, and a negative electrode material mixture layer adhering to the core material, wherein
the negative electrode material mixture layer includes a particulate carbon material;
the particulate carbon material has a breaking strength of 100 MPa or more; and
in a diffraction pattern of the negative electrode material mixture layer measured by wide-angle X-ray diffractometry, a ratio of an intensity I(101) of a peak attributed to (101) plane to an intensity I(100) of a peak attributed to (100) plane satisfies 1.0<I(101)/I(100)<3.0, and a ratio of an intensity I(110) of a peak attributed to (110) plane to an intensity I(004) of a peak attributed to (004) plane satisfies 0.25≦I(110)/I(004)≦0.45.

2. The negative electrode for a non-aqueous electrolyte secondary battery in accordance with claim 1, wherein
the particulate carbon material is a particulate composite carbon having a natural graphite portion and an artificial graphite portion,
the artificial graphite portion is present on a surface of the natural graphite portion, and
a weight ratio of the artificial graphite portion in the particulate composite carbon is 60 to 90% by weight.

3. The negative electrode for a non-aqueous electrolyte secondary battery in accordance with claim 1, wherein the particulate carbon material has a surface roughness Ra of 0.2 to 0.6 μm.

4. The negative electrode for a non-aqueous electrolyte secondary battery in accordance with claim 1, wherein the particulate carbon material has an amorphous carbon layer on a surface thereof.

5. The negative electrode for a non-aqueous electrolyte secondary battery in accordance with claim 1, wherein
the particulate carbon material includes particles of 5 μm or smaller in a ratio of 5% by weight or less, and
the particulate carbon material has a volumetric particle size distribution, where
a diameter at 50% volume accumulation is 2 to 3.5 times as large as a diameter at 10% volume accumulation, and
a diameter at 90% volume accumulation is 2 to 2.7 times as large as the diameter at 50% volume accumulation.

6. The negative electrode for a non-aqueous electrolyte secondary battery in accordance with claim 1, wherein the negative electrode material mixture layer has a packing density of 1.6 to 1.8 g/cm³.

7. The negative electrode for a non-aqueous electrolyte secondary battery in accordance with claim 1, wherein the particulate carbon material has a BET specific surface area of 1 to 5 m²/g.

8. A method for producing a negative electrode for a non-aqueous electrolyte secondary battery, the method comprising the steps of:
mixing natural graphite particles with a pitch, to prepare a first precursor;
heating the first precursor at 600 to 1000° C. to convert the pitch into a polymerized pitch, thereby to prepare a second precursor;
heating the second precursor at 1100 to 1500° C. to carbonize the polymerized pitch, thereby to prepare a third precursor; and
heating the third precursor at 2200 to 2800° C. to graphitize the carbonized polymerized pitch, thereby to form agglomerates of particulate composite carbon.

9. The method for producing a negative electrode for a non-aqueous electrolyte secondary battery in accordance with claim 8, further comprising the step of processing the agglomerates of particulate composite carbon until a surface roughness Ra reaches 0.2 to 0.6 μm.

10. A non-aqueous electrolyte secondary battery comprising a positive electrode, the negative electrode of claim 1, a separator interposed therebetween, and a non-aqueous electrolyte.
